(19) United States
(12) Patent Application Publication
(10) Pub. No.: US 2023/0332897 A1
(43) Pub. Date: Oct. 19, 2023

(54) POSITION ESTIMATION APPARATUS

(71) Applicant: Mitsubishi Electric Corporation, Tokyo (JP)

(72) Inventors: Ken HIKASA, Tokyo (JP); Kohei Mori, Tokyo (JP); Nariaki Takehara, Tokyo (JP)

(73) Assignee: Mitsubishi Electric Corporation, Tokyo (JP)

(21) Appl. No.: 18/179,763

(22) Filed: Mar. 7, 2023

(30) Foreign Application Priority Data
Apr. 14, 2022 (JP) 2022-066690

(51) Int. Cl. G01S 19/14; G01S 19/24; G01S 19/35; G01S 19/42; G01C 21/00

(52) U.S. Cl. CPC G01S 19/14; G01S 19/24; G01S 19/35; G01S 19/42; G01C 21/3863

(57) ABSTRACT

A position estimation apparatus comprises: a satellite positioning device for calculating satellite positioning position-information based on satellite information; an autonomous positioning device for calculating autonomous positioning position-information based on vehicle information; a geographic map information storage device for storing geographic map information; a positioning-device estimation device for estimating a positioning device whose error of estimation position on a mobile object becomes minimum based on first position information and the geographic map information, and for calculating positioning-device information related to the positioning device; and a position estimation device for calculating second position information based on the satellite and autonomous positioning position-information and the positioning-device information, wherein the positioning-device estimation device estimates a positioning device to be changed over thereto, before its positioning accuracy will be reduced; and the position estimation device verifies go/no-go determination of usage on the positioning device estimated, and estimates a position of the mobile object.

### BACKGROUND OF THE INVENTION

### Field of the Invention

The disclosure of the present application relates to a position estimation apparatus for estimating a position of a mobile object.

### Description of the Related Art

Positional or position information of a motor vehicle in which vehicle information gives for it is acquired by utilizing positioning satellites in a satellite positioning system such as the GPS (Global Positioning System), GNSS (Global Navigation Satellite System), OZSS (Quasi-Zenith Satellite System), and the like. However, in the acquisition of a position utilizing positioning satellites, there exists a positioning error(s) originating in delay of a signal(s) (radio waves) in through the ionosphere, multipath due to a building(s) or the like, the disruption of the signal(s), and so forth. In order to mitigate an influence of the error(s), there exists a technology of dead reckoning, for example. Dead reckoning is a technology by which a positional estimation is carried out by using an angular velocity obtained from a gyroscope sensor and a vehicle speed obtained from a vehicle speed sensor. However, when dead reckoning is carried out with reference to a satellite positioning position whose accuracy is reduced, there arises a problem in that the accuracy of a position by positioning it by means of the dead reckoning is also reduced at the same time.

In order to address those problems as described above, in Patent Document 1, a technology is disclosed in which an individual satellite positioning position is made as a starting point, and then a relative locus is estimated and held based on a dead-reckoning navigation-scheme, whereby, when a positioning signal transmitted from a positioning satellite is disrupted, a relative locus before the increase of a satellite positioning error(s) is inherited, and an estimation position based on a dead-reckoning navigation-scheme is calculated, so that the reduction of accuracy on the estimation position is prevented by means of the dead reckoning navigation-scheme.

In addition, in Patent Document 2, a technology is disclosed in which position estimation is performed by changing over a positioning means from one to another based on a running environment of a mobile object being targeted or on the neighboring environment thereof, whereby highly accurate position estimation is continued during the running of the mobile object.
[Patent Document 1] Japanese Patent Publication No. 6965720
[Patent Document 2] Japanese Patent Publication No. 6671570

According to a position detection device described in Patent Document 1, a relative locus before the increase of a satellite positioning error(s) is inherited, and then an estimation position based on a dead-reckoning navigation-scheme is calculated, so that the estimation of a position by means of the dead-reckoning navigation-scheme is continued. However, determination related to the increase of a satellite positioning error(s) is performed in accordance with a state of satellite information, so that, for example, it would be probable that a relative locus ought to be inherited is not correctly selected, when satellite information on which the influence of multipath is exerted results in being used for the determination.

In addition, according to a position estimation device described in Patent Document 2, a changeover of positioning means is carried out from one to another among those positioning means based on a running environment of a mobile object being targeted, or on the neighboring environment thereof. However, the verification is not performed in a sufficient manner whether a changeover of positioning means is appropriate or not, and so, in a case in which, for example, a positioning means having been changed over is inappropriate, it would be probable that the reduction of the accuracy on an estimation position is caused after the changeover having been carried out.

### SUMMARY OF THE INVENTION

The present disclosure of the application concerned has been directed at solving those problems as described above, and an object of the disclosure is to provide a position estimation apparatus which is capable of preventing the reduction of the accuracy on an estimation position at the time of changing over a positioning system or means.

A position estimation apparatus disclosed in the present disclosure of the application concerned, being a position estimation apparatus for estimating a position of a vehicular or mobile object, comprises:
a satellite information acquisition unit for outputting satellite information obtained through a satellite signal(s) acquired by a receiver, situated in a satellite positioning system, mounted on the mobile object;
a satellite positioning unit for calculating to be outputted therefrom satellite positioning position-information being position information of the mobile object which is derived in accordance with satellite information outputted from the satellite information acquisition unit;
a vehicle information acquisition unit mounted on the mobile object, for outputting vehicle information obtained through a sensor signal(s) acquired by a sensor(s);
an autonomous positioning unit for calculating to be outputted therefrom autonomous positioning position-information being position information of the mobile object which is derived in accordance with vehicle information outputted from the vehicle information acquisition unit;
a geographic map information storage unit for storing geographic map information;
a positioning-means estimation unit for estimating from among a plurality of positioning means a positioning means whose error of estimation position on the mobile object becomes minimum at a location in first position information being position information in use for the mobile object on the basis of the first position information and on that of the geographic map information, and for calculating positioning-means information being information related to the positioning means being estimated from among the plurality of positioning means; and
a position estimation device for calculating second position information on the basis of the satellite positioning position-information, on that of the autonomous positioning position-information and on that of the positioning-means information.

According to the position estimation apparatus disclosed in the disclosure of the application concerned, it is possible to continue highly accurate position estimation, during the running of a mobile object, by estimating its suitable positioning means, on the basis of the geographic map information and on that of the first position information.

### BRIEF DESCRIPTION OF DRAWINGS

FIG. 1 is diagram illustrating positioning systems with respect to a mobile object on which a position estimation apparatus according to Embodiment 1 is mounted;

FIG. 2 is a block diagram illustrating a configuration of the position estimation apparatus according to Embodiment 1;

FIG. 3 is a flowchart schematically showing the contents of position estimation processing in the position estimation apparatus according to Embodiment 1;

FIG. 4 is a flowchart schematically showing the contents of satellite positioning processing in the position estimation apparatus according to Embodiment 1;

FIG. 5 is a flowchart schematically showing the contents of autonomous positioning processing in the position estimation apparatus according to Embodiment 1;

FIG. 6 is a flowchart schematically showing the contents of running road-route estimation processing in the position estimation apparatus according to Embodiment 1;

FIG. 7 is a flowchart schematically showing the contents of positioning-means estimation processing in the position estimation apparatus according to Embodiment 1;

FIG. 8 is a flowchart schematically showing the contents of position calculation processing in the position estimation apparatus according to Embodiment 1;

FIG. 9 is a block diagram illustrating a configuration of a position estimation apparatus according to Embodiment 2;

FIG. 10 is a flowchart schematically showing the contents of running road-route acquisition processing in the position estimation apparatus according to Embodiment 2; and

FIG. 11 is a diagram showing an example of a hardware configuration of the position estimation apparatus according to the embodiments each.

### DETAILED DESCRIPTION OF THE PREFERRED EMBODIMENTS

Hereinafter, the explanation will be made referring to the drawings for Embodiment 1. Note that, in each of the figures, the explanation will be made for the same or corresponding members, portions or parts by designating the same reference numerals and symbols.

### Embodiment 1

### Configuration of Embodiment 1

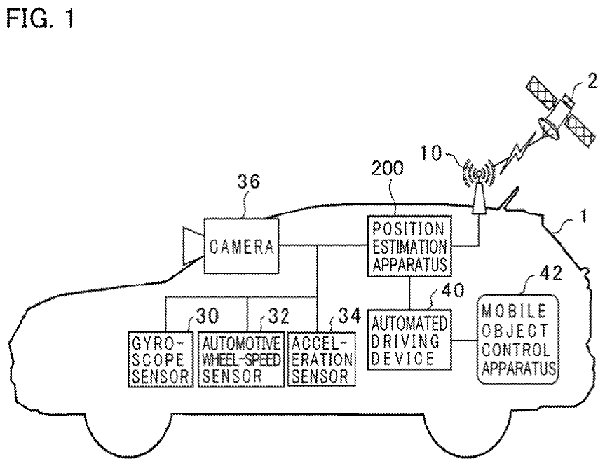

FIG. 1 is a diagram illustrating a vehicular or mobile object 1 on which its apparatus and related devices including a position estimation apparatus 200 according to the embodiment are mounted, and positioning means or systems in their entirety with respect to the mobile object 1.

The mobile object 1 comprises the position estimation apparatus 200, and sensors in use for autonomous positioning of the mobile object 1 (also referred to as “onboard sensors”) where a gyroscope sensor 30, an automotive wheel-speed sensor 32, an acceleration sensor 34 and a camera 36 are provided as the onboard sensors; and the mobile object comprises an automatic or automated driving device 40 for performing its controls related to its automated driving, and further comprises a mobile object control apparatus 42 including a drive device, a brake device, a steering device and the like for performing the respective driving/braking of the mobile object 1 and its steering on the basis of instructions of the automated driving device 40. In addition to those, the position estimation apparatus 200 comprises, for the sake of satellite positioning in a satellite positioning system, a receiver 10 (hereinafter, referred to as a global navigation satellite system or GNSS receiver 10) which receives a satellite signal from a positioning satellite 2. In FIG. 1, a motor vehicle is illustrated as the mobile object 1 in an exemplary case.

It should be noted that, in FIG. 1, the position estimation apparatus 200 is illustrated in the figurative diagram as if the position estimation apparatus only receives a satellite signal from the positioning satellite 2 by way of the GNSS receiver 10; however, there exists a plurality of positioning satellites each identical to the positioning satellite 2 under actual circumstances, so that it is configured in such an arrangement that pieces of positioning information are received from at least four or more of such positioning satellites 2 at the same time for the sake of positioning.

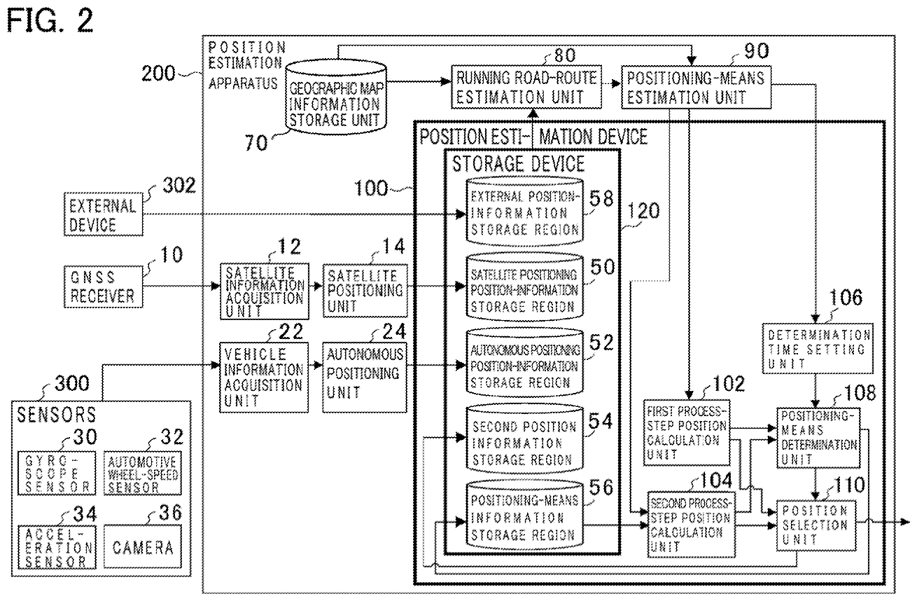

FIG. 2 is a block diagram illustrating a configuration of the position estimation apparatus 200. As illustrated in FIG. 2, the position estimation apparatus 200 comprises: a running road-route estimation unit 80 into which geographic map information from a geographic map information storage unit 70 and position estimation information from a storage device 120 of a position estimation device 100 are inputted; and a positioning-means estimation unit 90 into which geographic map information from the geographic map information storage unit 70 and estimated running road-route information from the running road-route estimation unit 80 are inputted, for outputting estimated positioning-means information with respect to the position estimation device 100.

The position estimation apparatus 200 comprises: a satellite information acquisition unit 12 into which satellite information from the GNSS receiver 10 is inputted; a satellite positioning unit 14 for carrying out satellite positioning on the basis of satellite information from the satellite information acquisition unit 12; a vehicle information acquisition unit 22 into which pieces of output information from the sensors 300 of the gyroscope sensor 30, the automotive wheel-speed sensor 32, the acceleration sensor 34, the camera 36 and so forth are inputted; and an autonomous positioning unit 24 for carrying out dead-reckoning or autonomous positioning on the basis of vehicle information from the vehicle information acquisition unit 22.

In FIG. 2, the sensors 300 are illustrated in the configuration to include the plurality of onboard sensors such as the gyroscope sensor 30, the automotive wheel-speed sensor 32, the acceleration sensor 34, the camera 36 and so forth; however, it is not necessarily limited to such a configuration. Namely, these sensors 300 may include a single onboard sensor or a plurality of onboard sensors on an as-needed basis, and so, include at least one or more of onboard sensors.

In the position estimation device 100, the storage device 120 is included; and the storage device 120 includes an external position-information storage region 58 in which external position-information obtained by an external device 302 is stored, a satellite positioning position-information storage region 50 for storing satellite positioning position-information obtained by the satellite positioning unit 14, an autonomous positioning position-information storage region 52 for storing autonomous positioning position-information obtained by the autonomous positioning unit 24, a second position information storage region 54 for storing positional or position information obtained by a position selection unit 110 as will be described latex, and a positioning-means information storage region 56 for storing positioning-means information obtained by a positioning-means determination unit 108 as will be described later.

In addition, the position estimation device 100 includes: a first process-step position calculation unit 102 and a determination time setting unit 106 into each of which estimated positioning-means information from the positioning-means estimation unit 90 is inputted; a second process-step position calculation unit 104 into which the estimated positioning-means information from the positioning-means estimation unit 90 and positioning-means information from the positioning-means information storage region 56 are inputted; the positioning-means determination unit 108 for performing determination on a positioning system or means, based on the information from the first process-step position calculation unit 102, on that from the second process-step position calculation unit 104 and on that from the determination time setting unit 106; and the position selection unit 110 for performing a position selection based on the information from the first process-step position calculation unit 102, on that from the second process-step position calculation unit 104 and on that from the positioning-means determination unit 108. Determined positioning-means information having been obtained by the positioning-means determination unit 108 is stored into the positioning-means information storage region 56. Position selection information having been obtained by the position selection unit 110 is outputted into the automated driving device 40, and also stored into the second position information storage region 54.

### Processing in Embodiment 1

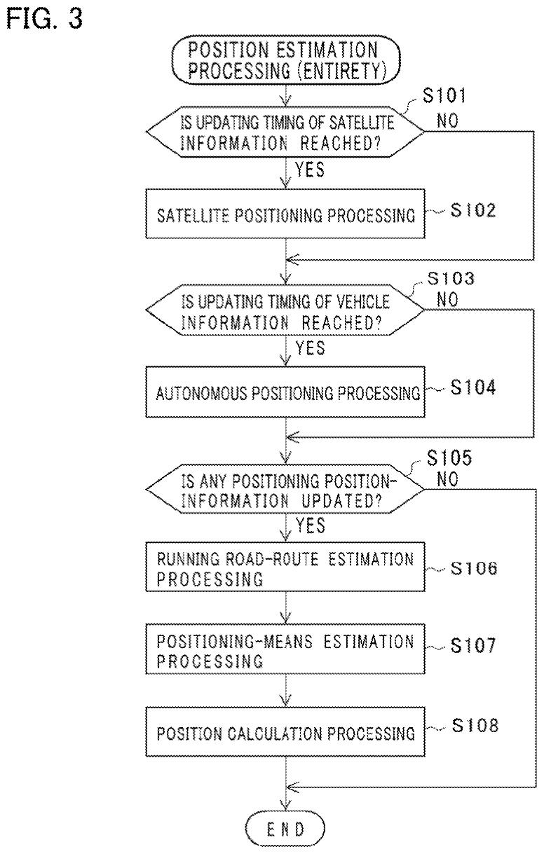

The explanation will be made referring to the flowcharts shown in FIG. 3 through FIG. 8 for the general outlines of the processing performed by the position estimation apparatus 200.

In the position estimation apparatus 200, position estimation processing such as that shown in FIG. 3 is repeated.

The satellite information acquisition unit 12 performs determination, at Step S101, whether updating timing of satellite information is reached or not. The updating timing of satellite information corresponds to reception timing of a satellite signal by means of the GNSS receiver 10. Here, when updating timing of satellite information is reached, the processing proceeds to Step S102. Meanwhile, when updating timing of the satellite information is not reached, selection “NO” is given at Step S101, so that the processing proceeds to Step S103.

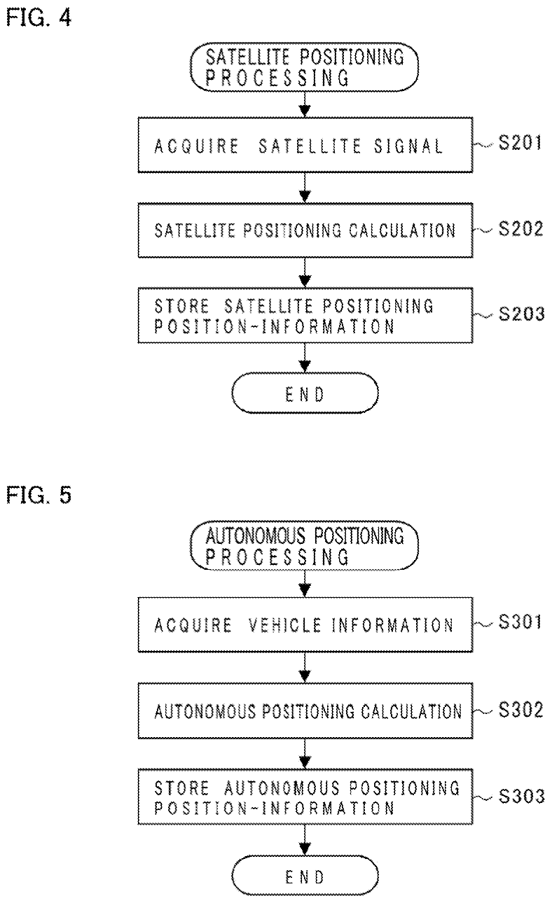

The satellite positioning unit 14 carries out, at Step S102, satellite positioning processing, so that satellite positioning position-information is calculated to be outputted from the satellite positioning unit. The explanation for the satellite positioning processing will be made later in detail referring to FIG. 4. After having carried out Step 6102, the processing proceeds to Step S103.

The vehicle information acquisition unit. 22 performs determination, at Step S103, whether updating timing of vehicle information is reached or not. The updating timing of vehicle information corresponds to the timing when the vehicle information acquisition unit 22 acquires a sensor signal from each kind of sensors among the sensors 300 mounted on the mobile object 1. Here, when updating timing of vehicle information is reached, the processing proceeds to Step S104. Meanwhile, when updating timing of the vehicle information is not reached, selection “NO” is given at Step S103, so that the processing proceeds to Step S105.

The autonomous positioning unit 24 carries out, at Step S104, autonomous positioning processing, so that autonomous positioning position-information is calculated to be outputted from the autonomous positioning unit. The explanation for the autonomous positioning processing will be made later in detail referring to FIG. 5. After having carried out Step S104, the processing proceeds to Step S105.

The position estimation device 100 determines, at Step S105, whether satellite positioning position-information is updated at Step S102, and/or whether autonomous positioning position-information is updated at Step S104. Namely, the determination is performed whether any one of the pieces of positioning position information is updated or not. Here, when at least either one is satisfied between a case in which satellite positioning position-information is updated at Step S102 and a case in which autonomous positioning position-information is updated at Step S104, the processing proceeds to Step S106. Meanwhile, when the satellite positioning position-information is not updated at Step S102, and also when the autonomous positioning position-information is not updated at Step S104, selection “NO” is given at Step S105, so that the position estimation processing is ended.

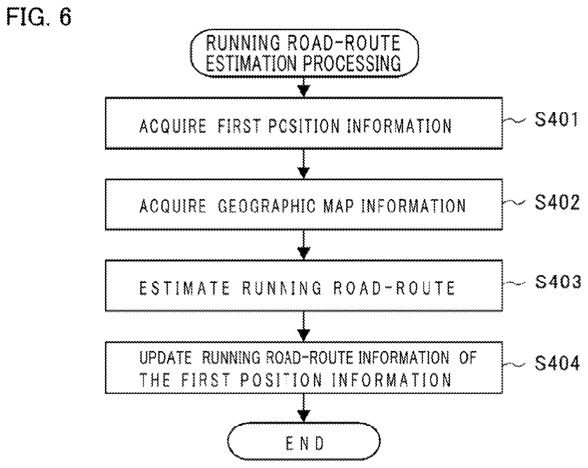

The running road-route estimation unit 80 carries out, at Step S106, running road-route estimation processing. The explanation for the running road-route estimation processing will be made later in detail referring to FIG. 6.

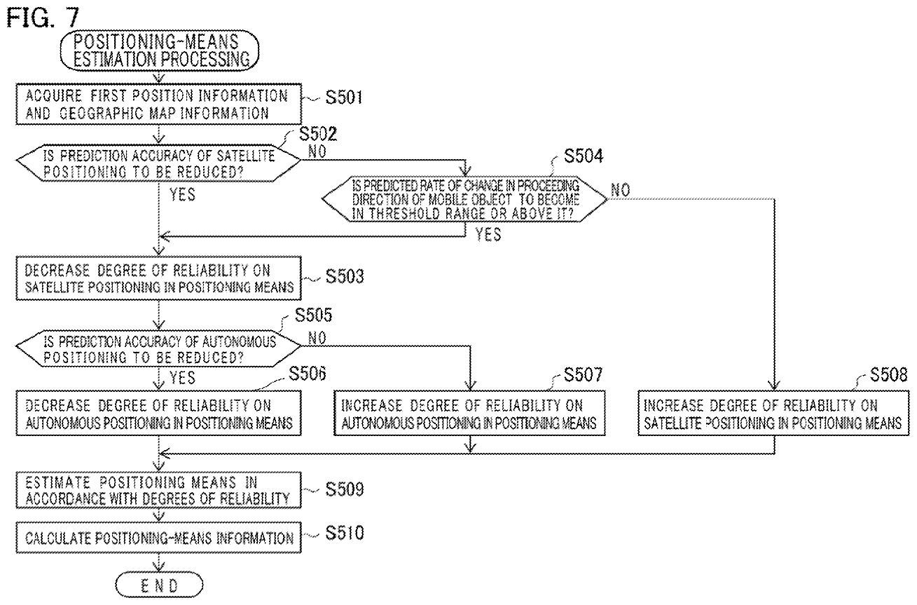

The positioning-means estimation unit 90 carries out, at Step S107, positioning-means estimation processing. The explanation for the positioning-means estimation processing will be made later in detail referring to FIG. 7.

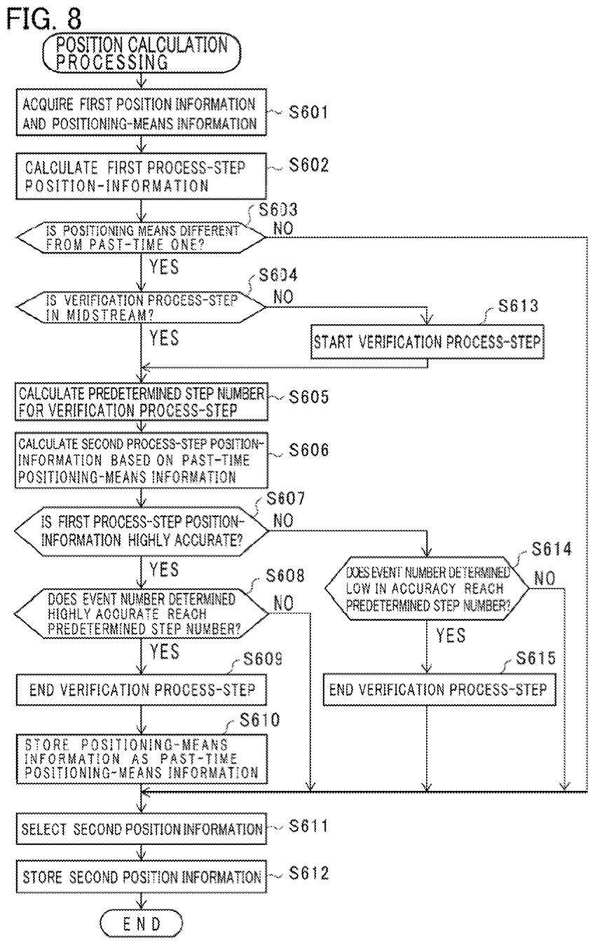

The position estimation device 100 carries out, at Step S108, position calculation processing. The explanation for the position calculation processing will be made later in detail referring to FIG. 8. After having carried out Step S108, the position estimation processing is ended.

The explanation will be made referring to FIG. 4 for specific processing contents of satellite positioning processing.

The satellite information acquisition unit 12 acquires, at Step S201, a satellite signal from the positioning satellite 2 by means of the GUSS receiver 10.

By using the satellite signal having been acquired at Step S201, a satellite positioning calculation is performed by means of the satellite positioning unit 14, so that satellite positioning position-information is calculated to be outputted therefrom which is constituted of a result of the satellite positioning calculation, and is constituted of satellite information (Step S202).

The satellite positioning position-information having been calculated at Step S202 is stored in the satellite positioning position-information storage region 50 where the position estimation device 100 includes thereinside (Step S203). The satellite positioning position-information having been stored is used in running road-route estimation processing, positioning-means estimation processing and position calculation processing as these will be described later. After having carried out Step S203, the satellite positioning processing is ended.

The explanation will be made referring to FIG. 5 for specific processing contents of autonomous positioning processing.

The vehicle information acquisition unit 22 acquires, at Step S301, vehicle information from the onboard sensors 300 such as the gyroscope sensor 30, the automotive wheel-speed sensor 32, the acceleration sensor 34 and the camera 36.

By using the vehicle information having been acquired at Step S301, an autonomous positioning calculation is performed by means of the autonomous positioning unit 24, so that autonomous positioning position-information is calculated to be outputted therefrom (Step S302). The autonomous positioning position-information includes a result of the autonomous positioning calculation and the vehicle information. Note that, as for the autonomous positioning, all of the gyroscope sensor 30, the automotive wheel-speed sensor 32, the acceleration sensor 34 and the camera 36 are not necessarily required, but it is suitable to arrange that as long as autonomous positioning can be performed by combining these sensors; and in addition, by using a sensor(s) capable of performing autonomous positioning, it is possible to obtain an operation- and/or working-effect similar to the operation- and/or working-effect described in the embodiment by using such a sensor(s) other than the gyroscope sensor 30, the automotive wheel-speed sensor 32, the acceleration sensor 34, the camera 36 and so forth.

The autonomous positioning position-information having been calculated at Step S302 is stored in the autonomous positioning position-information storage region 52 where the position estimation device 100 includes thereinside (Step S303). The autonomous positioning position-information having been stored is used in running road-route estimation processing, positioning-means estimation processing and position calculation processing as these will be described later. After having carried out Step S303, the autonomous positioning processing is ended.

The explanation will be made referring to FIG. 6 for specific processing contents of running road-route estimation processing.

The running road-route estimation unit 80 acquires, at Step S401, first position information from the storage device 120 where the position estimation device 100 includes thereinside. The storage device 120 is constituted of the satellite positioning position-information storage region 50, the autonomous positioning position-information storage region 52, the second position information storage region 54, the positioning-means information storage region 56 and the external position-information storage region 58. In the external position-information storage region 58, external position-information being the information related to a present-time or current position of the mobile object 1 is stored which is acquired through the external device 302. As for the first position information, any one piece of information may be utilized by selecting the one among previous or past-time satellite positioning position-information, previous or past-time autonomous positioning position-information, previous or past-time second position information as will be described later and external position-information, or two or more of these pieces of information may be utilized by selecting them and then combining them with one another. Namely, at least any one piece of information is utilized among past-time satellite positioning position-information, past-time autonomous positioning position-information, past-time second position information as will be described later, and external position-information. In what follows, the same also applies to other embodiments. For example, the amount of memory usage may be cut down by utilizing past-time satellite positioning position-information and past-time autonomous positioning position-information as the first position information, and, at the same time therewith, by taking on a configuration excluding the second position information storage region 54. Note that, as an example, a case is indicated in which past-time satellite positioning position-information and past-time autonomous positioning position-information are selected and utilized as the first position information; however, similar selection and configuration therefor may not be necessarily taken on, and so, different selection and configuration therefor may also be taken on.

The running road-route estimation unit 80 acquires, at Step S402, geographic map information from the geographic map information storage unit 70. As for the geographic map information, at least one piece or more of information is included among pieces of road information in which a running road-route of the mobile object 1 can be identified, as those pieces of information on a road shape, a diverting or merging point, an intersection and the like, and is also included among pieces of information related to the interruption of a satellite positioning signal and/or those of information related to causing multipath, such as pieces of information on a tunnel, an overpass or underpass intersection, and a constructed structure. Moreover, it is desirable that the geographic map information further includes, as road information, the information as block lines capable of identifying a lane(s) in which the mobile object 1 runs. Note that, as for the geographic map information storage unit 70, a dynamic map may also be suitably used in which, by communicating with a server(s) of an operation control system through a radio communications network of mobile lines for example, a position(s) of a pedestrian(s) and/or that of another mobile object such as the mobile object 1 or the like are updated in real time as the geographic map information. By using such a dynamic map, it becomes possible for the running road-route estimation unit 80 to preliminarily estimate a road-route by which, for example, a position of an obstacle thereon such as a malfunctioning or failed motor vehicle abruptly causing its failure is grasped at once, and by which the obstacle will be avoided.

The running road-route estimation unit 80 calculates, at Step S403, a present-time time or current position of the mobile object 1 on a geographic map including a running or proceeding direction and a running or proceeding speed, on the basis of the first position information having been acquired at Step S401 and on that of the geographic map information having been acquired at Step S402, by verifying the first position information through comparison with the geographic map information (i.e., map matching). Moreover, the running road-route estimation unit 80 estimates, from the current position of the mobile object 1 and from the geographic map information, a running road-route on the geographic map on which the mobile object 1 is predicted to run in the future, and calculates running road-route information including an estimation result of the running road-route. At this time, as for the estimation of the running road-route, a single road-route may also be suitable, or a plurality of road-routes may as well be suitable on which the mobile object 1 is expected to run from this time forward. When a plurality of road-routes is estimated, the degrees of reliability on estimation results each may be calculated on the basis of a current position of the mobile object 1 for every one of the road-routes.

The running road-route estimation unit 80 adds, at Step S404, the running road-route information having been calculated at Step S403 to the first position information, and updates running road-route information of the first position information. After having carried out Step S404, the running road-route estimation processing is ended.

The explanation will be made referring to FIG. 7 for specific processing contents of positioning-means estimation processing.

At Step S501, the positioning-means estimation unit 90 acquires from the running road-route estimation unit 80 first position information including running road-route information, and also acquires from the geographic map information storage unit 70 geographic map information including a running road-route(s) and its neighboring information. Here, the neighboring information in which the geographic map information includes is the information exerting an influence on the positioning accuracy in the neighborhood of running road-route, for example, the information of the height of a constructed structure such as a high-rise building(s), an elevated bridge and/or the like.

The positioning-means estimation unit 90 performs determination, at Step S502, whether there exists or not a location or site where the accuracy of satellite positioning (also referred to as “prediction accuracy,” which is applicable hereinafter in a similar fashion) is to be reduced on a running road-route of the mobile object 1 to run in the future, on the basis of the running road-route information having been acquired at Step S501, and on that of the geographic map information having been acquired thereat. Here, when determination is performed in which there exists a location (site) where the accuracy of satellite positioning is to be reduced on a running road-route of the mobile object 1 to run in the future, the processing proceeds to Step S503. Moreover, when the degree of reliability on satellite information is temporarily reduced originating in a malfunction of the GNSS receiver 10, it may be adopted that, by performing similar determination, the determination is reflected to the estimation of a positioning means. Meanwhile, when determination is performed in which there does not exist a site where the accuracy of the satellite positioning is to be reduced on the running road-route of the mobile object 1 to run in the future, selection “NO” is given at Step S502, so that the processing proceeds to Step S504. Note that, as a site where the accuracy of satellite positioning is reduced, for example, a road(s) in a tunnel, that under an intersecting overpass road, that between high-rise buildings and the like can be named. In a tunnel or under an intersecting overpass road, the GNSS receiver 10 undergoes difficulty in directly receiving a satellite signal(s), so that the accuracy of satellite positioning is reduced. In addition, on a road between high-rise buildings, the accuracy of the satellite positioning is reduced due to a case in which the positioning satellite 2 capable of directly capturing a satellite signal (s) is limited only in vicinity to the zenith, and/or a case in which a satellite signal from the positioning satellite 2 is reflected on a wall surface(s) of a surrounding high-rise building(s), for example, and is inputted into the GNSS receiver 10 as indirect radio waves (what is termed as “multipath”) or the like.

The positioning-means estimation unit 90 decreases, at Step S503, a parameter related to the degree of reliability on satellite positioning in a positioning means. Here, the parameter is made in relationship to running road-route information so as to correspond to a position on a running road-route of the mobile object 1. According to this arrangement, at the time when the positioning-means estimation unit 90 estimates a positioning means at Step S509 as will be described later, weighting in a usage level of satellite positioning is suitably decreased in accordance with position information of the mobile object 1.

The positioning-means estimation unit 90 performs determination, at Step S504, whether or not the rate of change in a running or proceeding direction of the mobile object 1 is to become in a predetermined threshold range or above it on along a running road-route of the mobile object 1 to run in the future. Here, when determination is performed in which, on along a running road-route of the mobile object 1 to run in the future, the rate of change in a proceeding direction of the mobile object 1 (also referred to as a “predicted rate of change,” which is applicable hereinafter in a similar fashion) is to become in a threshold range determined in advance or above it, selection “YES” is given at Step S504, so that the processing proceeds to Step S503. This corresponds to a case in which, for example, there exists a curve having a large curvature on along a running road-route of the mobile object 1. Meanwhile, when determination is performed in which, on along a running road-route of the mobile object 1 to run in the future, the predicted rate of change in a proceeding direction of the mobile object 1 is not to become in the threshold range determined in advance or above it, selection “NO” is given at Step S504, so that the processing proceeds to Step S508. Note that, a scheme of increasing or decreasing a parameter related to the degree of reliability may be set in relation to a threshold range determined for the increase or decrease each in advance, and such a threshold range determined in advance may also be set in a plurality of threshold ranges. For example, in relation to decreasing a parameter related to the degree of reliability on satellite positioning at Step S503, and with respect to the curvature “1/r” of a running road-route of the mobile object 1 and to the magnitudes of threshold ranges “a” and “b” (n.b., a<b), the threshold ranges “a” and “b” may each be set in such a manner that: when “a≤(the curvature 1/r)<b,” a parameter related to the degree of reliability on satellite positioning is decreased in accordance with the rate of change in the proceeding direction, because the rate of change in a proceeding direction of the mobile object 1 is in a threshold range “a” determined in advance or above it; and when “b≤(the curvature 1/r),” a parameter related to the degree of reliability on satellite positioning is decreased, regardless of the rate of change in the proceeding direction, so as to give the degree of reliability on satellite positioning to zero “0,” because the rate of change in a proceeding direction of the mobile object 1 is in a threshold range “b” determined in advance or above it. This corresponds in particular to a case in which, in relation to the threshold range “b,” a proceeding direction of the mobile object 1 cannot be estimated in good accuracy by satellite positioning in accordance with a case in which the proceeding direction of the mobile object 1 changes to a large extent during an acquisition time-period of a satellite signal from the positioning satellite 2, at the time of running along a curve having a large curvature and also at a high speed level, and/or at the time of making a right or left turn at an intersection.

The positioning-means estimation unit 90 performs determination, at Step S505, whether there exists or not a site where prediction accuracy of autonomous positioning is to be reduced on a running road-route of the mobile object 1 to run in the future, on the basis of the first position information including running road-route information having been acquired at Step S501, and on that of the geographic map information having been acquired thereat. Here, when determination is performed in which there exists a site where prediction accuracy of autonomous positioning is to be reduced on a running road-route of the mobile object 1 to run in the future, selection “YES” is given at Step S505, so that the processing proceeds to Step S506. Moreover, when the degree of reliability on vehicle information is reduced originating in the reduction of camera performance due to backlight and/or degradation cf a white coat-line(s) itself, and/or originating in a malfunction of a onboard sensor(s) itself or the like, it may be adopted that, by performing similar determination, the determination is reflected to the estimation of a positioning means. Meanwhile, when determination is performed in which there does not exist a site where prediction accuracy of the autonomous positioning is to be reduced on the running road-route of the mobile object 1 to run in the future, selection “NO” is given at Step S505, so that the processing proceeds to Step S507. Note that, as a site where the accuracy of autonomous positioning is reduced, a tollbooth, a servicing area (SA) with parking lots and/or the like placed on along an expressway can be named when the camera 36, for example, is used as for the onboard sensors 300. There are many sites where coat-lines are not drawn in vicinity to a tollbooth and/or in a servicing area SA, and so, on the basis of white coat-line information acquired from geographic map information and the camera 36, it is difficult to carry out highly accurate estimation of a position of the mobile object 1 by means of the autonomous positioning.

The positioning-means estimation unit 90 decreases, at Step S506, a parameter related to the degree of reliability on autonomous positioning in a positioning means. Here, the parameter is made in relationship to running road-route information so as to correspond to a position on a running road-route of the mobile object 1. According to this arrangement, at the time when a positioning means is changed over, weighting in a usage level of autonomous positioning, namely, its degree of reliability is suitably decreased in accordance with such position information of the mobile object 1. In addition, the parameter related to the degree of reliability on autonomous positioning may be decreased for each of the onboard sensors. After having carried out Step S506, the processing proceeds to Step S509.

The positioning-means estimation unit 90 increases, at Step S507, a parameter related to the degree of reliability on autonomous positioning in a positioning means. Here, the parameter is made in relationship to running road-route information so as to correspond to a position on a running road-route of the mobile object 1. According to this arrangement, at the time when a positioning means is changed over, weighting in a usage level of autonomous positioning, namely, its degree of reliability is suitably increased in accordance with such position information of the mobile object 1. This corresponds to a case in which, for example, when the rate of change in a proceeding direction of the mobile object 1 is large, vehicle information from the acceleration sensor 34 and/or the gyroscope sensor 30 each having a shorter acquisition time-period is priority used for the positioning, instead of using a satellite positioning signal having a longer acquisition time-period. The parameter related to the degree of reliability on autonomous positioning may be increased for each of the onboard sensors. After having carried out Step 3507, the processing proceeds to Step S509.

The positioning-means estimation unit 90 increases, at Step S508, a parameter related to the degree of reliability on satellite positioning in a positioning means. Here, the parameter is made in relationship to running road-route information so as to correspond to a position on a running road-route of the mobile object 1. According to this arrangement, at the time when a positioning means is changed over, weighting in a usage level of satellite positioning, namely, its degree of reliability is suitably increased in accordance with such position information of the mobile object 1. This is a case in which there does not exist a site where the accuracy of satellite positioning is to be reduced on along a running road-route of the mobile object 1 to run in the future, and also, the rate of change in a proceeding direction of the mobile object 1 is smaller. Namely, this corresponds to a case in which, in the environment such as open skies for example, signal strength of satellite signals each is high and also the mobile object 1 runs on a straight road-route.

The positioning-means estimation unit 90 modifies, at Step S509, weighting of satellite positioning and that of autonomous positioning on the basis of the aforementioned parameter related to the degree of reliability on satellite positioning and on that of the aforementioned parameter related to the degree of reliability on autonomous positioning, so that the positioning-means estimation unit estimates the most suitable positioning means.

The positioning-means estimation unit 90 calculates to be outputted therefrom, at Step S510, positioning-means information including the information related to a positioning means having been estimated at Step S509, a parameter related to the degree of reliability on satellite positioning at each position on a running road-route, a parameter related to the degree of reliability on autonomous positioning at each position on the running road-route, and the like. The positioning-means information is made use of in position calculation processing as this will be described later. After having carried out Step S510, the positioning-means estimation processing is ended.

It should be noted that, in the embodiment, weighting of satellite positioning and that of autonomous positioning are modified in accordance with the degree of reliability on autonomous positioning and that on satellite positioning each, and the most suitable positioning means is estimated; however, a similar effect can be obtained in such an arrangement that, on the basis of a result of go/no-go determination of usage on a positioning means for which each of the autonomous positioning unit 24 and the satellite positioning unit 14 performs, the most suitable positioning means is estimated by means of a pattern determined in advance. For example, when determination is performed in which the autonomous positioning unit 24 performs go determination of usage on autonomous positioning, whereas the satellite positioning unit 14 performs no-go determination of usage on satellite positioning, it is suitable that the positioning-means estimation unit 90 estimates autonomous positioning as the most suitable positioning means. Meanwhile, for example, when determination is performed in which the autonomous positioning unit 24 performs no-go determination of usage on autonomous positioning, whereas the satellite positioning unit 14 performs go determination of usage on satellite positioning, it is also suitable that the positioning-means estimation unit 90 estimates satellite positioning as the most suitable positioning means. Moreover, for example, when determination is performed in which the autonomous positioning unit 24 performs go determination of usage on autonomous positioning and in which the satellite positioning unit 14 performs go determination of usage on satellite positioning, it is suitable that the positioning-means estimation unit 90 estimates a combination of the autonomous positioning and the satellite positioning as the most suitable positioning means. Here, as for the combination of autonomous positioning and satellite positioning, a combination may be applicable in which, for example, satellite positioning is combined with autonomous positioning which complements between a time-period of satellite positioning and that of satellite positioning, and/or compound or complex positioning may also be applicable in which, while performing a positioning calculation by defining satellite information and autonomous positioning position-information as inputs therefor, an error of autonomous positioning is appropriately compensated by using a Kalman filter.

The explanation will be made referring to FIG. 8 for specific processing contents of the position calculation processing.

At Step S601, the position estimation device 100 acquires from the positioning-means estimation unit 90 first position information including running road-route information, and also positioning-means information having been calculated by the positioning-means estimation unit 90.

The first process-step position calculation unit 102 where the position estimation device 100 includes thereinside performs a positioning calculation at Step S602 on the basis of the first position information including running road-route information having been acquired at Step S601 and on that of the positioning-means information having been acquired thereat, and calculates first process-step position-information.

The positioning-means determination unit 108 where the position estimation device 100 includes thereinside compares, at Step S603, positioning-means information having been acquired at Step S601 with previous or past-time positioning-means information stored in the positioning-means information storage region 56 where the position estimation device 100 includes thereinside, and performs determination whether or not positioning-means information (namely, positioning means) having been acquired at Step S601 is updated to positioning-means information different from past-time positioning-means information (namely, positioning means). When determination is performed in which the positioning means having been acquired at Step S601 is updated to a positioning-means different from a previous or past-time positioning means, selection “YES” is given at Step S603, so that the processing proceeds to Step S604. Meanwhile, when determination is performed in which the positioning means having been acquired at Step S601 is not updated to a positioning-means different from the past-time positioning means, selection “NO” is given at Step S603, so that the processing proceeds to Step S611. This corresponds to a case in which, in the positioning-means estimation unit 90, its estimation has been performed so that it is not necessary to change over a positioning means.

The positioning-means determination unit 108 where the position estimation device 100 includes thereinside performs, at Step S604, determination whether or not a verification process-step, which is a process-step for performing go/no-go determination of usage on positioning-means information, for performing comparative verification between first process-step position-information and second process-step position-information has already been started, namely, whether or not the verification process-step is in midstream. When determination is performed in which the verification process-step for performing comparative verification between first process-step position-information and second process-step position-information has already been started, selection “YES” is given at Step S604, so that the processing proceeds to Step 3605. Meanwhile, when determination is performed in which the verification process-step for performing comparative verification between first process-step position-information and second process-step position-information has not yet been started, selection “NO” is given at Step 3604, so that the processing proceeds to Step S613.

The determination time setting unit 106 where the position estimation device 100 includes thereinside sets, at Step S605, a verification time of the verification process-step for performing comparative verification between first process-step position-information and second process-step position-information. Here, the verification time is defined by, for example, the number of execution step(s) to perform a verification process-step, a duration or continuation time to perform a verification process-step, the number of pieces of effective data during a verification process-step, and so forth. Meanwhile, the definition of a verification time is not necessarily bound by those, so that it is distinctly possible to variably set any one of those. Moreover, in relation to each timing to start the verification process-step, to intermit it, to restart it or to end it, the timing is not necessarily bound by for each definition of the verification time, so that it is distinctly possible to variably set any one of those. For example, as a factor for determining a verification time of the verification process-step and each timing to start it, to intermit it, to restart it or to end it, it may also be suitable for using a speed of the mobile object 1, a shape of a running road-route on which the mobile object 1 is to run in the future, a reception environment of a satellite signal(s), and the like. In addition, for example, in a case in which a verification process-step is carried out at a time when a positioning means of the mobile object 1 is changed over from satellite positioning to autonomous positioning on the basis of positioning-means information having been calculated by means of the positioning-means estimation unit 90, an acquisition time-period of data is in general different between the satellite positioning and the autonomous positioning, and thus, it is more desirable to adopt, as a verification time, the number of execution step(s) to perform the verification process-step than to adopt a continuation time to perform the verification process-step. Moreover, at a time when a similar verification process-step is carried out, and, for example, when the mobile object 1 performs a route change so that its proceeding direction is changed to a large extent, the verification process-step is made intermittent in a temporary manner in a route change zone or section of the mobile object 1, and then the verification process-step is restarted from after the route change is ended, whereby it is possible to lower noise which becomes a cause of reducing the accuracy of the verification process-step. Note that, hereinafter, a case is indicated in the embodiment in which the number of execution step(s) to perform a verification process-step is treated by defining the number of execution step(s) as a verification time. However, the verification time may not necessarily be defined in a similar fashion, and so, a case of different definition may also be suitable for.

The determination time setting unit. 106 where the position estimation device 100 includes thereinside calculates to define, at Step S605, the number of step(s) to end the verification process-step for performing comparative verification between first process-step position-information and second process-step position-information by the positioning-means determination unit 108, on the basis of the first position information including running road-route information having been acquired at Step S601, and on that of the positioning-means information having been acquired thereat. This corresponds to a case in which, for example, when the determination has been performed in the positioning-means estimation unit 90 so that positioning accuracy by a satellite(s) is to be reduced on along a running road-route in the future, a verification time of the verification process-step is determined on the basis of a location where positioning accuracy by the satellite(s) is to be reduced and on that of a current position of the mobile object 1.

The second process-step position calculation unit 104 where the position estimation device 100 includes thereinside performs, at Step S606, positioning calculation on the basis of the first position information having been acquired at Step S601 and on that of past-time positioning-means information stored in the positioning-means information storage region 56 where the position estimation device 100 includes thereinside, and the second process-step position calculation unit calculates to be outputted therefrom second process-step position-information.

The positioning-means determination unit 108 where the position estimation device 100 includes thereinside carries out, at Step S607, the verification process-step for performing comparative verification between first process-step position-information and second process-step position-information, and performs determination whether or not an error of first process-step position-information with respect to second process-step position-information is less than a threshold value determined in advance (namely, whether the first process-step position-information is highly accurate or not). When determination is performed in which the error of the first process-step position-information with respect to the second process-step position-information is less than the threshold value determined in advance, selection “YES” is given at Step S607, so that the processing proceeds to Step S608. At this time of occasion, the positioning-means determination unit 108 counts up the number of such event(s) that determination is performed in which the error of the first process-step position-information with respect to the second process-step position-information is less than the threshold value determined in advance. Meanwhile, when determination is performed in which the error of the first process-step position-information with respect to the second process-step position-information is at the threshold value determined in advance or more (namely, the first process-step position-information is low in its accuracy), selection “NO” is given at Step S607, so that the processing proceeds to Step S614. At this time of occasion, the positioning-means determination unit 108 counts up the number of such event(s) that determination is performed in which an error of the first process-step position-information with respect to the second process-step position-information is at the threshold value determined in advance or more. Furthermore, the threshold value is not limited to a threshold value determined in advance, and so, for example, it may be adopted also to use a threshold value which is set in accordance with the degree of reliability or the like on each positioning means included in positioning-means information.

At Step S608, the positioning-means determination unit 108 where the position estimation device 100 includes thereinside performs determination whether or not the number of event(s) where the positioning-means determination unit 108 has determined at Step S607 that an error of first process-step position-information with respect to second process-step position-information is less than a threshold value determined in advance reaches at the number of such event(s) determined in advance and having been calculated at Step S605. When determination is performed in which the number of event (s) where the positioning-means determination unit 108 has determined at Step S607 that the error of the first process-step position-information with respect to the second process-step position-information is less than the threshold value determined in advance reaches at the number of such event (s) determined in advance, selection “YES” is given at Step S608, so that the processing proceeds to Step S609. At this time of occasion, the number of event(s) where the positioning-means determination unit 108 has determined at Step S607 that the error of the first process-step position-information with respect to the second process-step position-information is less than the threshold value determined in advance is initialized by zero “0.” Meanwhile, when determination is performed in which the number of event(s) where the positioning-means determination unit 108 has determined and counted up at Step S607 that the error of the first process-step position-information with respect to the second process-step position-information is less than the threshold value determined in advance does not reach at the number of such event(s) determined in advance, selection “NO” is given at Step S608, so that the processing proceeds to Step S611.

The positioning-means determination unit 108 where the position estimation device 100 includes thereinside ends the verification process-step at Step S609.

The position estimation device 100 stores, at Step S610, positioning-means information having been calculated by the positioning-means estimation unit 90 into the positioning-means information storage region 56 where the position estimation device 100 includes thereinside as previous or past-time positioning-means information.

At Step S611, the position selection unit 110 where the position estimation device 100 includes thereinside selects first process-step position-information as second position information, when a positioning means having been estimated by the positioning-means estimation unit 90 at Step S603 is identical to past-time positioning-means information stored in the positioning-means information storage region 56 where the position estimation device 100 includes thereinside. This corresponds to a case in which, in the positioning-means estimation unit 90, its estimation has been performed, in which it is not necessary to change over the positioning means that has been estimated therein. Or in another case, when the number of event(s) where determination has been performed at Step S608 in which an error of first process-step position-information with respect to second process-step position-information is less than a threshold value determined in advance reaches at the number of such event(s) which is determined in advance and has been calculated at Step S605, the first process-step position-information is selected as second position information. This corresponds to a case in which, in the positioning-means estimation unit 90, its estimation has been performed so that it is necessary to change over a positioning means, and to a case in which the positioning means has been changed over, so that the positioning means is adopted in the position estimation device 100 because the reduction of positioning accuracy is not presumed. Meanwhile, at Step S614, when the number of event (s) where determination has been performed in which an error of first process-step position-information with respect to second process-step position-information is at a threshold value determined in advance or more reaches at the number of event(s) which is determined in advance and has been calculated at Step S605, the second process-step position-information is selected as second position information. This corresponds to a case in which, in the positioning-means estimation unit 90, its estimation has been performed so that it is necessary to change over a positioning means, whereas the changeover of the positioning means is rejected in the position estimation device 100 because the reduction of positioning accuracy is presumed when the positioning means is to be changed over.

The position estimation device 100 retains, at Step S612, the second position information having been selected at Step S611 in the second position information storage region 54 where the position estimation device 100 includes thereinside for storage. After having carried out Step S612, the position calculation processing is ended.

The positioning-means determination unit 108 where the position estimation device 100 includes thereinside starts a verification process-step at Step S613. After having carried out Step S613, the processing proceeds to Step S605.

At Step S614, the positioning-means determination unit 108 where the position estimation device 100 includes thereinside performs determination whether or not the number of event(s) where the positioning-means determination unit 108 has determined at Step S607 that an error of first process-step position-information with respect to second process-step position-information is at a threshold value determined in advance or more (namely, low in accuracy) reaches at the number of such event (s) determined in advance. When determination is performed in which the number of event(s) where the positioning-means determination unit 108 has determined at Step S607 that the error of the first process-step position-information with respect to the second process-step position-information is at the threshold value determined in advance or more reaches at the number of such event(s) determined in advance, selection “YES” is given at Step S614, so that the processing proceeds to Step S615. At this time of occasion, the number of event(s) where the positioning-means determination unit 108 has determined and counted up at Step S607 that the error of the first process-step position-information with respect to the second process-step position-information is at the threshold value determined in advance or more is initialized by zero “0.” Meanwhile, when determination is performed in which the number of event(s) where the positioning-means determination unit 108 has determined at Step S607 that the error of the first process-step position-information with respect to the second process-step position-information is at the threshold value determined in advance or more does not reach at the number of such event (s) determined in advance, selection “NO” is given at Step S614, so that the processing proceeds to Step S611.

The positioning-means determination unit 108 where the position estimation device 100 includes thereinside ends the verification process-step at Step S615. After having carried out Step S615, the processing proceeds to Step S611.

### Effects of Embodiment 1

The position estimation apparatus 200 of Embodiment 1 comprises: the satellite positioning unit 14 for calculating to be outputted therefrom satellite positioning position-information on the basis of satellite information; the autonomous positioning unit 24 for calculating to be outputted therefrom autonomous positioning position-information on the basis of vehicle information; the geographic map information storage unit 70 for storing geographic map information; the running road-route estimation unit 80 for estimating a running road-route on the basis of geographic map information and on that of first position information, and for calculating running road-route information; the positioning-means estimation unit 90 for estimating a positioning means whose error of estimation position on the mobile object 1 becomes minimum at a location in the first position information on the basis of the first position information and on that of the geographic map information, and for calculating positioning-means information being the information related to the positioning means; and the position estimation device 100 for calculating second position information on the basis of satellite positioning position-information, on that of autonomous positioning position-information and on that of positioning-means information. According to the above, the position estimation apparatus 200 estimates a suitable positioning means after having estimated a running road-route of the mobile object 1 to run in the future on the basis of geographic map information and on that of first position information, and the position estimation apparatus is further provided with a verification process-step related to go/no-go determination of changeover on the positioning means, whereby, before positioning accuracy of a present-time or current positioning means is to be reduced, the positioning means is changed over while its positioning accuracy is held as it is, and thus, it is possible for a running position of the mobile object 1. to continue highly accurate estimation on its position during the running of the mobile object 1.

### Embodiment 2

### Configuration of Embodiment 2

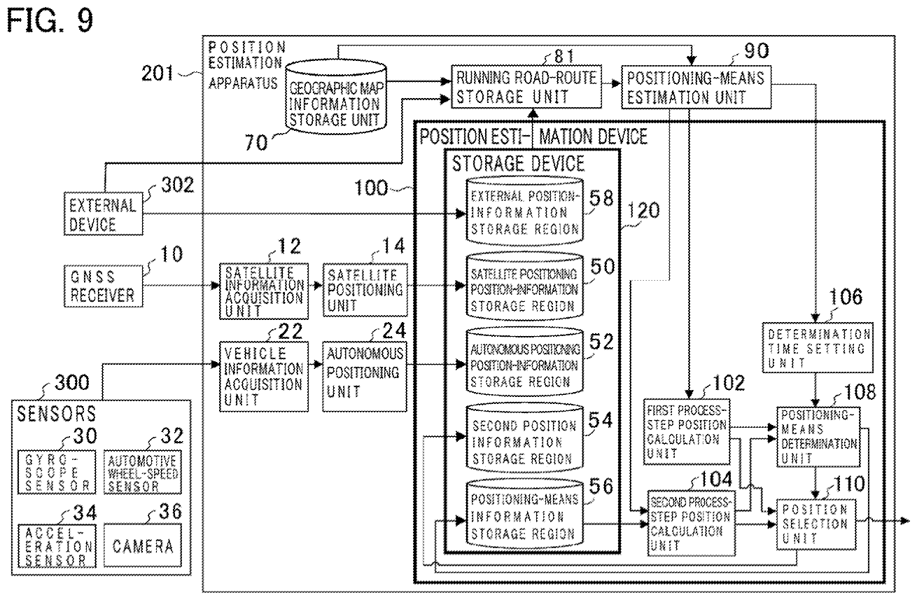

FIG. 9 is a block diagram illustrating a configuration of a position estimation apparatus 201 of Embodiment 2. The block diagram is a diagram in which, in the block diagram illustrating the configuration of the position estimation apparatus 200 of Embodiment 1 shown in FIG. 2, the running road-route estimation unit 80 is replaced by a running road-route storage unit 81.

### Processing in Embodiment 2

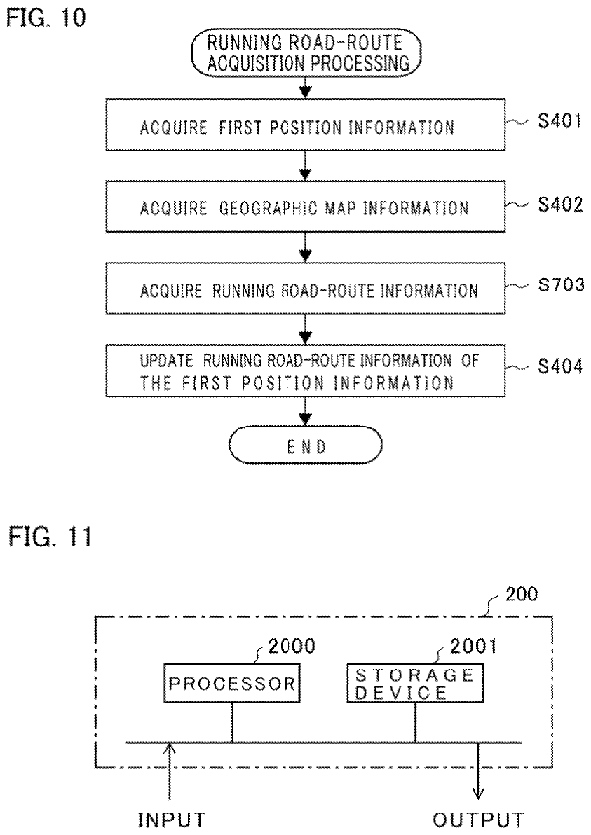

In Embodiment 2, the explanation will be made, referring to the flowcharts shown in FIG. 3 through FIG. 8 and that in FIG. 10, for the general outlines of the processing performed by the position estimation apparatus 201. In Embodiment 2, the running road-route estimation processing shown in FIG. 6 is replaced by running road-route acquisition processing shown in FIG. 10. In addition, the other processing performed by the position estimation apparatus 201 in Embodiment 2 is similar to the processing in such a manner that: in regard to each processing of the position estimation processing shown in FIG. 3 in Embodiment 1, the satellite positioning processing shown in FIG. 4 therein, the autonomous positioning processing shown in FIG. 5 therein, the positioning-means estimation processing shown in FIG. 7 therein, and the position calculation processing shown in FIG. 8 therein, the running road-route estimation unit 80 shall be read as the running road-route storage unit 81, and so, the running road-route estimation processing, as the running road-route acquisition processing.

The explanation will be made referring to FIG. 10 for specific processing contents of the running road-route acquisition processing.

In relation to Step S401, Step S402 and Step S404, these Steps are equivalent or similar to those in Embodiment 1, and thus their explanation will be omitted.

Step 3703 replaces Step S403 in such a manner that: at Step 3403 of Embodiment 1, the running road-route estimation unit 80 calculates a current position of the mobile object 1 including a proceeding direction and a proceeding speed on a geographic map, on the basis of first position information having been acquired at Step S401 and on that of geographic map information having been acquired at Step S402, by verifying the first position information through comparison with the geographic map information (i.e., map matching), and the running road-route estimation unit estimates from the current position of the mobile object 1 and from the geographic map information a running road-route on the geographic map on which the mobile object 1 is predicted to run in the future, so that running road-route information including an estimation result of the running road-route is calculated; and that, at Step S703, the running road-route storage unit 81 acquires running road-route information inputted from the external device 302, and calculates a current position of the mobile object 1 including a proceeding direction and a proceeding speed on the geographic map, on the basis of the first position information having been acquired at Step S401 and on that of the geographic map information having been acquired at Step S402, by verifying the first position information through comparison with the geographic map information (i.e., map matching). Here, the acquisition of running road-route information inputted from the external device 302 corresponds, for example, to a case in which an instruction(s) of a running road-route with respect to the mobile object 1 is received from an operation control center, and/or to a case in which an vehicle occupant of the mobile object 1 inputs a running road-route of the mobile object 1 via an onboard navigation system. At this time of occasion, the running road-route being inputted as above may also be suitable for a single road-route, or may as well be suitable for a plurality of road-routes.

### Effects of Embodiment 2

The position estimation apparatus 201 of Embodiment 2 comprises: the satellite positioning unit 14 for calculating to be outputted therefrom satellite positioning position-information on the basis of satellite information; the autonomous positioning unit 24 for calculating to be outputted therefrom autonomous positioning position-information on the basis of vehicle information; the geographic map information storage unit 70 for storing geographic map information; the running road-route storage unit 81 for acquiring running road-route information inputted in advance from the external device 302; the positioning-means estimation unit 90 for estimating a positioning means whose error of estimation position on the mobile object 1 becomes minimum at a location in first position information on the basis of the first position information and on that of the geographic map information, and for calculating positioning-means information being the information related to the positioning means; and the position estimation device 100 for calculating second position information on the basis of satellite positioning position-information, on that. of autonomous positioning position-information and on that of positioning-means information. According to the above, the position estimation apparatus 201 estimates a suitable positioning means after having acquired a running road-route of the mobile object 1 to run in the future on the basis of geographic map information and on that of first position information, and the position estimation apparatus is further provided with a verification process-step related to go/no-go determination of changeover on the positioning means, whereby, before positioning accuracy of a present-time or current positioning means is to be reduced, the positioning means is changed over while its positioning accuracy is held as it is, and thus, it is possible for a running position of the mobile object 1 to continue its highly accurate position estimation during the running of the mobile object 1. In addition, it is so arranged that running road-route information is enabled to be inputted externally by way of the external device 302, whereby it becomes possible to achieve highly accurate estimation on a positioning means even more on the basis of running road-route information whose degree of accuracy is higher than running road-route information having been estimated, and also, it is possible to mitigate a load of the running road-route acquisition processing in the position estimation apparatus 201.

It should be noted that, as an example of hardware is illustrated in FIG. 11, the position estimation apparatus 200 and the position estimation apparatus 201 are each constituted of a processor 2000 and a storage device 2001. The storage device 2001 is provided with a volatile storage device of a random access memory (RAM) or the like, and with a nonvolatile auxiliary storage device of a flash memory or the like, for example. In addition, in place of the flash memory, an auxiliary storage device of a hard disk may be provided with. The processor 2000 executes a program(s) inputted from the storage device 401. In this case, the program(s) is inputted into the processor 2000 from the auxiliary storage device by way of the volatile storage device. Moreover, the processor 2000 may output its data of a calculated result(s) or the like into the volatile storage device of the storage device 2001, or may store the data into the auxiliary storage device by way of the volatile storage device.

In the present disclosure of the application concerned, various exemplary embodiments and implementation examples are described; however, various features, aspects and functions described in one or a plurality of embodiments are not necessarily limited to the applications of a specific embodiment (s), but are applicable in an embodiment (s) solely or in various combinations.

Therefore, limitless modification examples not being exemplified can be presumed without departing from the scope of the technologies disclosed in Specification of the disclosure of the application concerned. For example, there arise cases which are included as a case in which at least one constituent element is modified, added or eliminated, and further a case in which at least one constituent element is extracted and then combined with a constituent element(s) of another embodiment.

What is claimed is:

1. A position estimation apparatus being a position estimation apparatus for estimating a position of a mobile object, the position estimation apparatus, comprising:
a satellite information acquisition device for outputting satellite information obtained through a satellite signal acquired by a receiver, situated in a satellite positioning system, mounted on the mobile object;
a satellite positioning device for calculating to be outputted therefrom satellite positioning position-information being position information of the mobile object which is derived in accordance with satellite information outputted from the satellite information acquisition device;
a vehicle information acquisition device mounted on the mobile object, for outputting vehicle information obtained through a sensor signal acquired by a sensor;
an autonomous positioning device for calculating to be outputted therefrom autonomous positioning position-information being position information of the mobile object which is derived in accordance with vehicle information outputted from the vehicle information acquisition device;
a geographic map information storage device for storing geographic map information;
a positioning-device estimation device for estimating from among a plurality of positioning devices a positioning device whose error of estimation position on the mobile object becomes minimum at a location in first position information being position information in use for the mobile object on a basis of said first position information and on that of the geographic map information, and for calculating positioning-device information being information related to said positioning device being estimated from among the plurality of positioning devices; and
a position estimation device for calculating second position information on a basis of the satellite positioning position-information, on that of the autonomous positioning position-information and on that of the positioning-device information.

2. The position estimation apparatus as set forth in claim 1, wherein
the position estimation device includes:
a positioning-device information storage region being capable of storing the positioning-device information at past-time thereinside as positioning-device information at past-time, and being capable of outputting it therefrom;
a first process-step position calculator for calculating to be outputted therefrom first process-step position-information on a basis of the satellite positioning position-information, on that of the autonomous positioning position-information and on that of the positioning-device information;
a second process-step position calculator for calculating to be outputted therefrom second process-step position-information on a basis of the satellite positioning position-information, on that of the autonomous positioning position-information and on that of the positioning-device information at past-time;
a positioning-device determination device for performing go or no-go determination of usage on the positioning-device information on a basis of the first process-step position-information and on that of the second process-step position-information, and also for updating the positioning-device information at past-time in the positioning-device information storage region to the positioning-device information, when a result of the go or no-go determination of usage on the positioning-device information gives go determination; and
a position selector for selecting either one between the first process-step position-information and the second process-step position-information as second position information on a basis of a result of the go or no-go determination of usage on the positioning-device information in the positioning-device determination device.

3. The position estimation apparatus as set forth in claim 2, wherein
the position estimation device further includes:
a determination time setting device for freely setting a determination time being a time required by the positioning-device determination device for performing its go or no-go determination of usage on the positioning-device information on a basis of said first position information.

4. The position estimation apparatus as set forth in claim 1, wherein
the position estimation device includes a satellite positioning position-information storage region for storing thereinside the satellite positioning position-information acquired by the satellite positioning device, and wherein
the satellite positioning position-information at past-time stored in the satellite positioning position-information storage region is used as said first position information.

5. The position estimation apparatus as set forth in claim 1, wherein
the position estimation device includes an autonomous positioning position-information storage region for storing thereinside the autonomous positioning position-information acquired by the autonomous positioning device, and wherein
the autonomous positioning position-information at past-time stored in the autonomous positioning position-information storage region is used as said first position information.

6. The position estimation apparatus as set forth in claim 1, wherein
the position estimation device includes a second position information storage region for storing thereinside said second position information acquired by the position estimation device, and wherein
said second position information at past-time stored in the second position information storage region is used as said first position information.

7. The position estimation apparatus as set forth in claim 1, wherein
the position estimation device includes an external position-information storage region for storing thereinside external position-information being position information inputted in advance from an external device, and wherein
the external position-information stored in the external position-information storage region is used as said first position information.

8. The position estimation apparatus as set forth in claim 1, wherein
said first position information includes running road-route information being information related to a running road-route on which the mobile object is to run in future, and the position estimation apparatus further comprising:
a running road-route estimation device for estimating a running road-route on which the mobile object is to run in future on a basis of the geographic map information and on that of said first position information, and for calculating the running road-route information, and wherein
the running road-route information calculated by the running road-route estimation device is defined as said first position information.

9. The position estimation apparatus as set forth in claim 7, wherein
said first position information further includes running road-route information being information related to a running road-route on which the mobile object is to run in future, and the position estimation apparatus further comprising:
a running road-route storage device for storing the running road-route information inputted in advance from an external device, and wherein
the running road-route information stored in the running road-route storage device is defined as said first position information.

10. The position estimation apparatus as set forth in claim 8, wherein the positioning-device estimation device performs, on a basis of the geographic map information and on that of said first position information, determination on a presence or absence of a location whose accuracy of position estimation by satellite positioning falls below a predetermined threshold value on a road-route along the running road-route, and also defines said positioning device to autonomous positioning before the mobile object is to reach at the location, when a result of the determination takes on a presence.

11. The position estimation apparatus as set forth in claim 9, wherein the positioning-device estimation device performs, on a basis of the geographic map information and on that of said first position information, determination on a presence or absence of a location whose accuracy of position estimation by satellite positioning falls below a predetermined threshold value on a road-route along the running road-route, and also defines said positioning device to autonomous positioning before the mobile object is to reach at the location, when a result of the determination takes on a presence.

12. The position estimation apparatus as set forth in claim 8, wherein the positioning-device estimation device estimates, on a basis of the geographic map information and on that of said first position information, a rate of change of direction being an amount of change in a proceeding direction of the mobile object in a time determined in advance on a road-route along the running road-route, and performs determination on a presence or absence of a location whose rate of change of the direction exceeds a predetermined threshold range; and also, the positioning-device estimation device defines said positioning device to autonomous positioning before the mobile object is to reach at the location, when a result of the determination takes on a presence.

13. The position estimation apparatus as set forth in claim 9, wherein the positioning-device estimation device estimates, on a basis of the geographic map information and on that of said first position information, a rate of change of direction being an amount of change in a proceeding direction of the mobile object in a time determined in advance on a road-route along the running road-route, and performs determination on a presence or absence of a location whose rate of change of the direction exceeds a predetermined threshold range; and also, the positioning-device estimation device defines said positioning device to autonomous positioning before the mobile object is to reach at the location, when a result of the determination takes on a presence.

14. The position estimation apparatus as set forth in claim 10, wherein the positioning-device estimation device estimates, on a basis of the geographic map information and on that of said first position information, a rate of change of direction being an amount of change in a proceeding direction of the mobile object in a time determined in advance on a road-route along the running road-route, and performs determination on a presence or absence of a location whose rate of change of the direction exceeds a predetermined threshold range; and also, the positioning-device estimation device defines said positioning device to autonomous positioning before the mobile object is to reach at the location, when a result of the determination takes on a presence.

15. The position estimation apparatus as set forth in claim 8, wherein the positioning-device estimation device performs, on a basis of the geographic map information and on that of said first position information, determination on a presence or absence of a location whose accuracy of position estimation by autonomous positioning falls below a predetermined threshold value on a road-route along the running road-route, and also defines said positioning device to satellite positioning before the mobile object is to reach at the location, when a result of the determination takes on a presence.

16. The position estimation apparatus as set forth in claim 9, wherein the positioning-device estimation device performs, on a basis of the geographic map information and on that of said first position information, determination on a presence or absence of a location whose accuracy of position estimation by autonomous positioning falls below a predetermined threshold value on a road-route along the running road-route, and also defines said positioning device to satellite positioning before the mobile object is to reach at the location, when a result of the determination takes on a presence.

17. The position estimation apparatus as set forth in claim 10, wherein the positioning-device estimation device performs, on a basis of the geographic map information and on that of said first position information, determination on a presence or absence of a location whose accuracy of position estimation by autonomous positioning falls below a predetermined threshold value on a road-route along the running road-route, and also defines said positioning device to satellite positioning before the mobile object is to reach at the location, when a result of the determination takes on a presence.

18. The position estimation apparatus as set forth in claim 12, wherein the positioning-device estimation device performs, on a basis of the geographic map information and on that of said first position information, determination on a presence or absence of a location whose accuracy of position estimation by autonomous positioning falls below a predetermined threshold value on a road-route along the running road-route, and also defines said positioning device to satellite positioning before the mobile object is to reach at the location, when a result of the determination takes on a presence.

19. The position estimation apparatus as set forth in claim 1, wherein
the position estimation device includes:
a satellite positioning position-information storage region for storing thereinside the satellite positioning position-information acquired by the satellite positioning device;
an autonomous positioning position-information storage region for storing thereinside the autonomous positioning position-information acquired by the autonomous positioning device;
a second position information storage region for storing thereinside said second position information acquired by the position estimation device; and
an external position-information storage region for storing thereinside external position-information being position information inputted in advance from an external device, and wherein
at least any one is used as said first position information among:
the satellite positioning position-information at past-time stored in the satellite positioning position-information storage region;
the autonomous positioning position-information at past-time stored in the autonomous positioning position-information storage region;
said second position information at past-time stored in the second position information storage region; and
the external position-information stored in the external position-information storage region.
